(19) United States
(12) Patent Application Publication
(10) Pub. No.: US 2007/0098607 A1
(43) Pub. Date: May 3, 2007

(54) Method for recycling thallium - 203 isotope in remnant solution of thallium - 201 radioisotope

(75) Inventors: Song-Un Tang, Taoyuan City (TW); Wuu-Jyh Lin, Taoyuan (TW)

Correspondence Address: TROXELL LAW OFFICE PLLC, SUITE 1404, 5205 LEESBURG PIKE, FALLS CHURCH, VA, 22041, US

(73) Assignee: Atomic Energy Council - Institute of Nuclear Energy Research

(21) Appl. No.: 11/260,426

(22) Filed: Oct. 28, 2005

(51) Int. Cl. C01F 13/00

(52) U.S. Cl. 423/2

(57) ABSTRACT

The present invention provides a method to recycle thallium-203 isotope from a remnant solution of thallium-201 radioisotope by using an ion exchange and a chemical precipitation; and, the thallium-203 obtained can be used in a single photon emission computed tomography or a myocardium diagnosis of nuclear medicine.

### FIELD OF THE INVENTION

The present invention relates to a method for recycling; more particularly relates to recycling Thallium(Tl)-203 isotope from a remnant electroplating solution of Tl-203 target or a remnant chemical Tl-201 solution with a recycling rate over 98% to be made into an electroplating solution or a solid thallous oxide used in nuclear medicine.

### DESCRIPTION OF THE RELATED ART

A prior art, “Tumor Imaging Agent of Gallium Dimercaptosuccinate”, is proclaimed in Taiwan, where a gallium(Ga)-67 dimercaptosuccinate compound having a dimercaptosuccinic acid labeled with Ga-67 radioisotope is obtained by a reaction of a radioactive 67GaCl and a dimercaptosuccinic acid to be a tumor imaging agent. Nevertheless, a radioisotope is hard to obtain so that the price is high. And, the recycling of the radioisotope with the purification is done with high cost. Hence, the prior art does not fulfill users' requests on actual use.

### SUMMARY OF THE INVENTION

The main purpose of the present invention is to provide a method for recycling Tl-203 isotope with high purity and high recycling rate from a remnant solution of Tl-201 radioisotope.

To achieve the above purpose, the present invention is a method for recycling Tl-203 isotope in a remnant solution of Tl-201 radioisotope, where, through a chemical precipitation, an amount of Tl-203 precipitates is obtained in a remnant electroplating solution of Tl-203 target or a remnant chemical Tl-201 solution; the precipitates having Tl-203 are collected and rinsed to obtain Tl-203 isotopes; and, the Tl-203 isotopes are dissolved in a sulphuric acid to obtain a target electroplating solution or are heated to 900° C. to obtain a solid Tl-203 oxide for easy storage. The present invention achieves a recycling rate over 98% and the chemical process flow is simple and convenient with high purity and high recycling rate through chemical precipitation and ion exchange; so, the present invention is used in an automatic or semi-automatic process to improve the convenience and the repetition of the recycling to save time and human resources. Accordingly, a novel method for recycling Tl-203 isotope in a remnant solution of Tl-201 radioisotope is obtained.

### BRIEF DESCRIPTION OF THE DRAWINGS

The present invention will be better understood from the following detailed descriptions of the preferred embodiments according to the present invention, taken in conjunction with the accompanying drawings, in which

FIG. 1 is a view showing a producing flow according to a first preferred embodiment of the present invention;

FIG. 2 is a view showing a producing flow according to a second preferred embodiment of the present invention;

FIG. 3 is a view showing results of recycling Tl-203 isotopes from remnant electroplating solutions according to the first preferred embodiment of the present invention;

FIG. 4 is a view showing results of recycling Tl-203 isotopes from remnant chemical solutions according to the second preferred embodiment of the present invention;

FIG. 5 is a view showing examination results of raw materials made of Tl-203 isotopes recycled from remnant electroplating solutions according to the first preferred embodiment of the present invention;

FIG. 6 is a view showing examination results of injections made of Tl-203 isotopes recycled from remnant electroplating solutions according to the first preferred embodiment of the present invention;

FIG. 7 is a view showing examination results of raw materials made of Tl-203 isotopes recycled from remnant chemical solutions according to the second preferred embodiment of the present invention; and

FIG. 8 is a view showing examination results of injections made of Tl-203 isotopes recycled from remnant chemical solutions according to the second preferred embodiment of the present invention.

### DESCRIPTION OF THE PREFERRED EMBODIMENTS

The following descriptions of the preferred embodiments are provided to understand the features and the structures of the present invention.

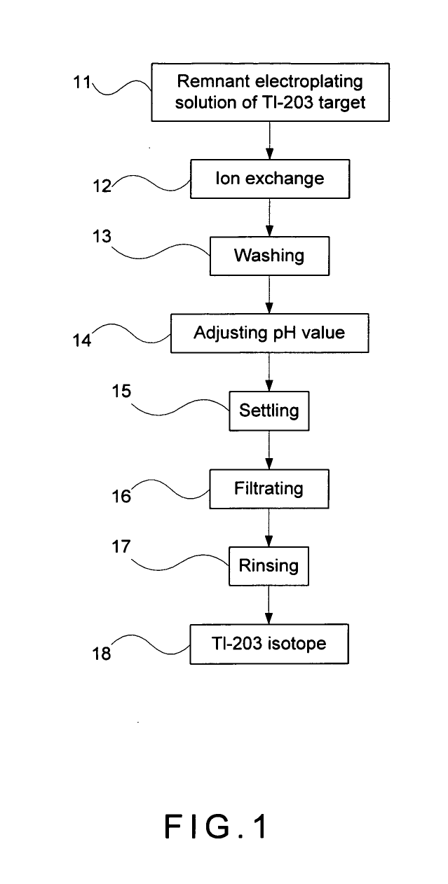

Please refer to FIG. 1, which is a view showing a producing flow according to a first preferred embodiment of the present invention. As shown in the figure, the present invention is a method for recycling TL-203 isotope in a remnant solution of TL-201 radioisotope, where a remnant electroplating solution of TL-203 target [11] is processed with an ion exchange [12] to remove an organic solvent; after processing the ion exchange [12], the remnant electroplating solution of TL-203 target [11] is washed [13] by using a sulphuric acid to obtain a Tl-203 solution; a pH (Potential of Hydrogen) value of the Tl-203 solution is adjusted [14] by using a NaOH solution to obtain a Tl-203 solution with a pH value of 12; the Tl-203 solution with a pH value of 12 is precipitated [15] by using a sulfide solution to obtain a solution having a black precipitate of thallous sulfide; the solution having a black precipitate of thallous sulfide is filtrated [16] by using a filtrating tank to separate the precipitate out of a recycled solution; and, the precipitate is rinsed [17] by using a NaOH solution to obtain a Tl-203 isotope [18]. The Tl-203 isotope [18] obtained is made into a solid thallous oxide by being heated to 900° C., or is made into a target electroplating solution with a dissolvent of sulphuric acid for recycling the Tl-203 isotope with a recycling rate over 98%.

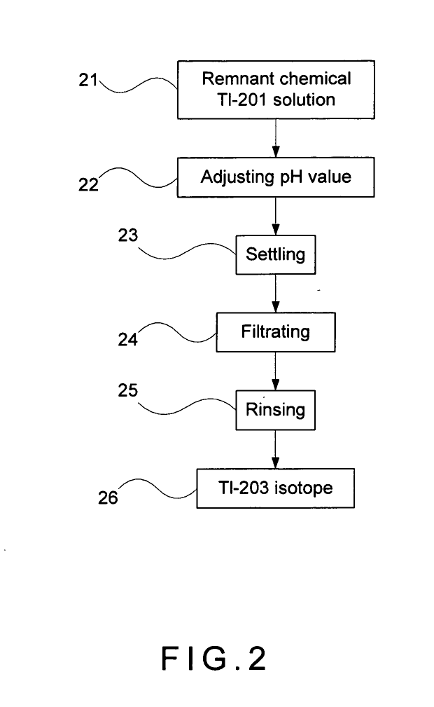

Please refer to FIG. 2, which is a view showing a producing flow according to a second preferred embodiment of the present invention. As shown in the figure, the present invention is a method for recycling TL-203 isotope in a remnant solution of TL-201 radioisotope, where a pH value of a remnant chemical Tl-201 solution [21] is adjusted [22] with a NaOH solution to obtain a Tl-201 solution having a pH value of 12; the Tl-201 solution having a pH value of 12 is precipitated [23] with a sulfide solution to obtain a solution having a precipitate of thallous sulfide; the solution having a precipitate of thallous sulfide is filtrated [24] by using a filtrating tank to separate the precipitate and a recycled solution; and, the precipitate is rinsed [25] with a NaOH solution to obtain a Tl-203 isotope [26]. The Tl-203 isotope [26] obtained can be heated to 900° C. to obtain a solid thallous oxide, or be dissolved with a sulphuric acid to obtain a target electroplating solution. By doing so circularly, a recycling rate over 98% can be achieved.

Thus, a novel method for recycling Tl-203 isotope in a remnant solution of Tl-201 radioisotope is obtained. For further understanding the present invention, some preferred embodiments are described as follows:

### EXAMPLE 1

Recycling Tl-203 isotopes from remnant electroplating solutions of Tl-203 targets

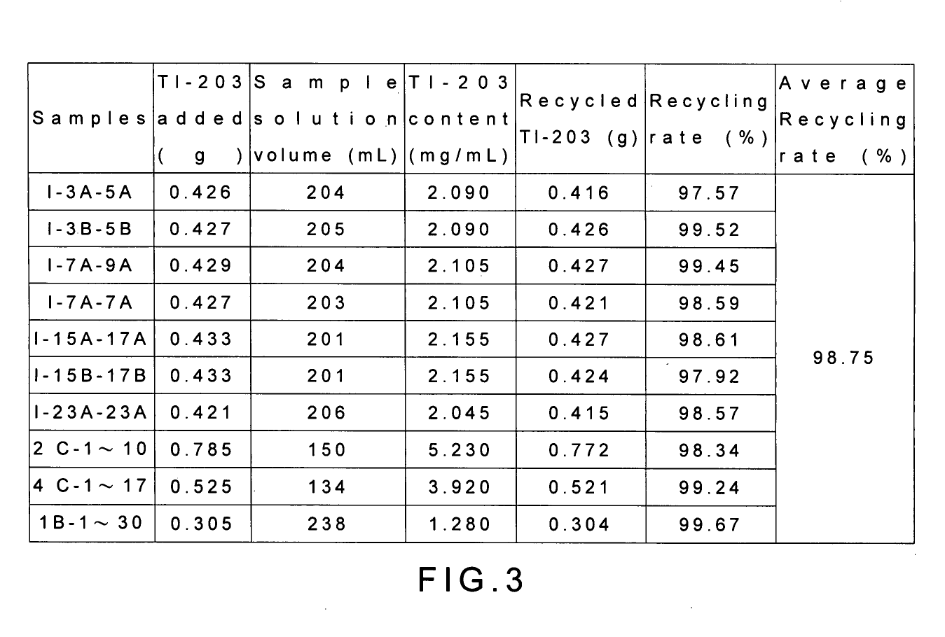

Please refer to FIG. 3, which is a view showing results of recycling Tl-203 isotopes from remnant electroplating solutions according to the first preferred embodiment of the present invention. As shown in the figure together with FIG. 1 referred, an electroplating solution of TL-203 target comprises a thallium sulfide in an organic solvent. When the electroplating solution is processed through an electroplating until less than 1 g (gram) of Tl-230 is left, a remnant electroplating solution of Tl-203 target [11] is obtained.

An ion exchange [12] is processed through the remnant electroplating solution of Tl-203 target [11] by using a 1 cm φ×10 cm L ion-exchange tube for H₂SO₄-form cation exchange resin and a SJ-1211H rolling motor of ATTO Corp., Japan to remove the organic solvent and absorb the Tl-203. After the ion exchange [12], Tl-203 is washed down [13] by using a 4N sulphuric acid to obtain a Tl-203 solution. A pH value of the Tl-203 solution is then adjusted [14] by using a NaOH solution to obtain a Tl-203 solution with a pH value of 12, where the pH value after the adjusting [14] lies between 12 and 13.5. The Tl-203 solution with a pH value of 12 is added with a saturated sulfide solution to be precipitated [15]. After being totally precipitated, the Tl-203 solution is stayed steady for 1 hour to obtain a solution having black precipitate of thallous sulfide. The Tl-203 solution is then moved into a semi-automatic vacuating filtration system, whose filtrating tank is of funnel-type made by KIMAX Corp. and whose filter plate is of elaborate-type with 4˜5.5 mm (millimeter) apertures, to be filtrated [16] to separate a precipitate out of a recycled solution. The recycled solution is poured into a wastes bucket, which can be circularly recycled for at least 20 times. The precipitate and the surfaces of the filtrating tank is rinsed [17] by using a NaOH solution and a distilled water to obtain a Tl-203 isotopes [18]. The solution after the rinsing is collected to be recycled, whose recycling rate is at least 97% and whose actual recycling rate is over 98%. For easy storage, the Tl-203 isotope [18] is heated to 900° C. to obtain a solid thallous oxide, or is dissolved in a sulphuric acid to obtain a target electroplating solution through diluting and evaporating.

### EXAMPLE 2

Recycling Tl-203 isotopes from remnant chemical Tl-201 solutions

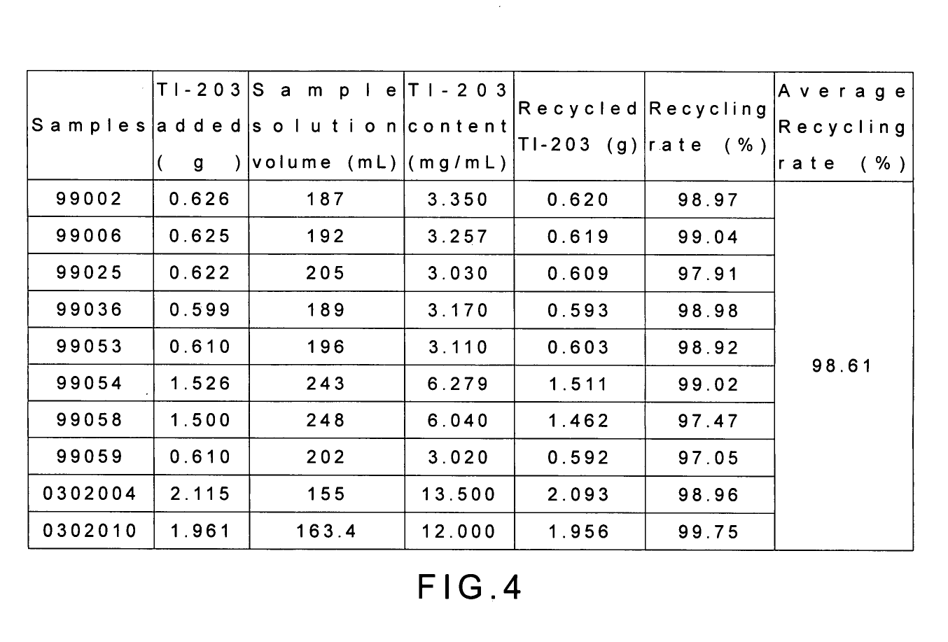

Please refer to FIG. 4, which is a view showing results of recycling Tl-203 isotopes from remnant chemical solutions according to the second preferred embodiment of the present invention. As shown in the figure together with FIG. 2 referred, a silver-plated target is electroplated with Tl-203 isotope according to the irradiation requirement for producing a 201 thallous chloride (201TlCl). The target is irradiated by a cyclotron and is deposited to wait for a decay. Then the target is taken out to be dissolved by using a dense nitric acid. Through a co-precipitation and a separation with ferric nitrate and dense ammonium hydroxide, the junk solution separated is a remnant chemical Tl-201 isolation solution [21], whose high-value condense Tl-203 isotope is weighted like the isotope electroplated on the target. The remnant chemical Tl-201 isolation solution [21] is deposited for 3˜4 months for a decay and then is lifted for a recycling.

A pH value of the remnant chemical Tl-201 isolation solution [21] is adjusted [22] with a NaOH solution to obtain a Tl-201 solution having a pH value of 12, where the pH value after the adjusting [22] lies between 12 and 13.5. The Tl-203 solution is then added with a saturated sulfide solution to be precipitated [23]. After being totally precipitated, the Tl-203 solution is stayed steady for 1 hour to obtain a solution having a black precipitate of thallous sulfide. The Tl-203 solution is then moved into a semi-automatic vacuating filtration system, whose filtrating tank is of funnel-type made by KIMAX Corp. and whose filter plate is of elaborate-type with 4˜5.5 mm (millimeter) apertures, to be filtrated [24] to separate a precipitate out of a recycled solution. The recycled solution is poured into a wastes bucket, which can be circularly recycled for at least 20 times. The precipitate and the surfaces of the filtrating tank is rinsed [25] by using a NaOH solution and a distilled water to obtain Tl-203 isotopes [26]. The solution after the rinsing is collected to be recycled, whose recycling rate is at least 97% and whose actual recycling rate is over 98%. For easy storage, the Tl-203 isotope [26] is heated to 900° C. to obtain a solid thallous oxide, or is dissolved in a sulphuric acid to obtain a target electroplating solution through diluting and evaporating.

### EXAMPLE 3

An application of electroplating solutions of TL-203 target recycled from Example 1 and Example 2

Electroplating solutions of TL-203 target recycled from Example 1 and Example 2 are loaded in an electroplating tank. The electroplating solution of TL-203 target is processed through an electroplating on an irradiation target of a cyclotron having a copper bottom and a silver surface. The irradiation target of the cyclotron is transported to an irradiation station of the cyclotron to be irradiated with protons of 29 MeV and 200 μA. After an accumulation of 1500 μAh through the irradiation, the irradiation target of the cyclotron is transported to a lead chamber for a chemical separation and purification. The Pb-201 isotope obtained after the nuclear reaction is deposited and is stayed steady for 32 hours to obtain Tl-201 with high-purity and high-quality from the Pb-201 solution through the separation and purification. With a quality control to conform to nuclear-medicine quality, the Tl-201 is made into an injection of 201TlCl to be used in a single photon emission computed tomography (SPECT) or a myocardium diagnosis.

### EXAMPLE 4

An application of solid 203 thallous oxide recycled from Example 1 and Example 2

The solid thallous-203 oxide recycled from Example 1 and Example 2 is dissolved in a sulphuric acid to obtain a Tl-203 electroplating solution and is loaded in an electroplating tank. The TL-203 electroplating solution is processed through an electroplating on an irradiation target of a cyclotron having a copper bottom and a silver surface. The irradiation target of the cyclotron is transported to an irradiation station of the cyclotron to be irradiated with protons of 29 MeV and 200 μA . After an accumulation of 1500 μAh through the irradiation, the irradiation target of the cyclotron is transported to a lead chamber for chemical separation and purification. The Pb-201 isotope obtained after the nuclear reaction is deposited and is stayed steady for 32 hours to obtain Tl-201 with high-purity and high-quality from the Pb-201 solution through the separation and purification. With a quality control to conform to nuclear-medicine quality, the Tl-201 is made into an injection of 201TlCl to be used in a SPECT or a myocardium diagnosis.

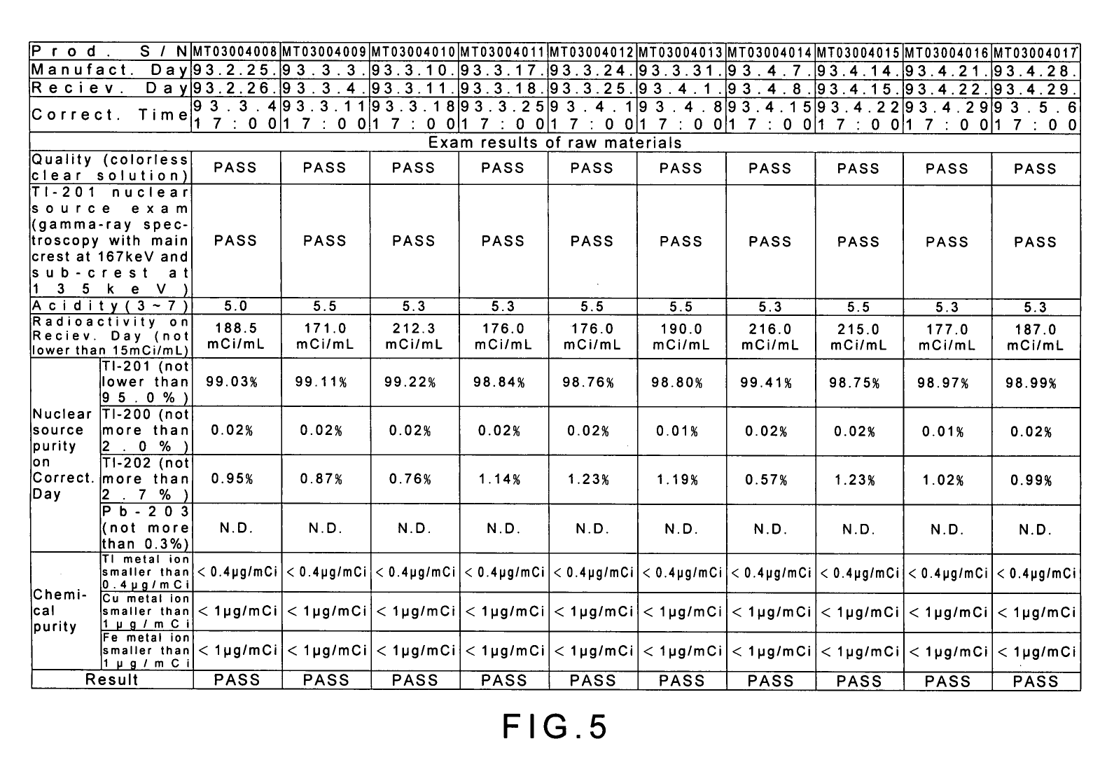

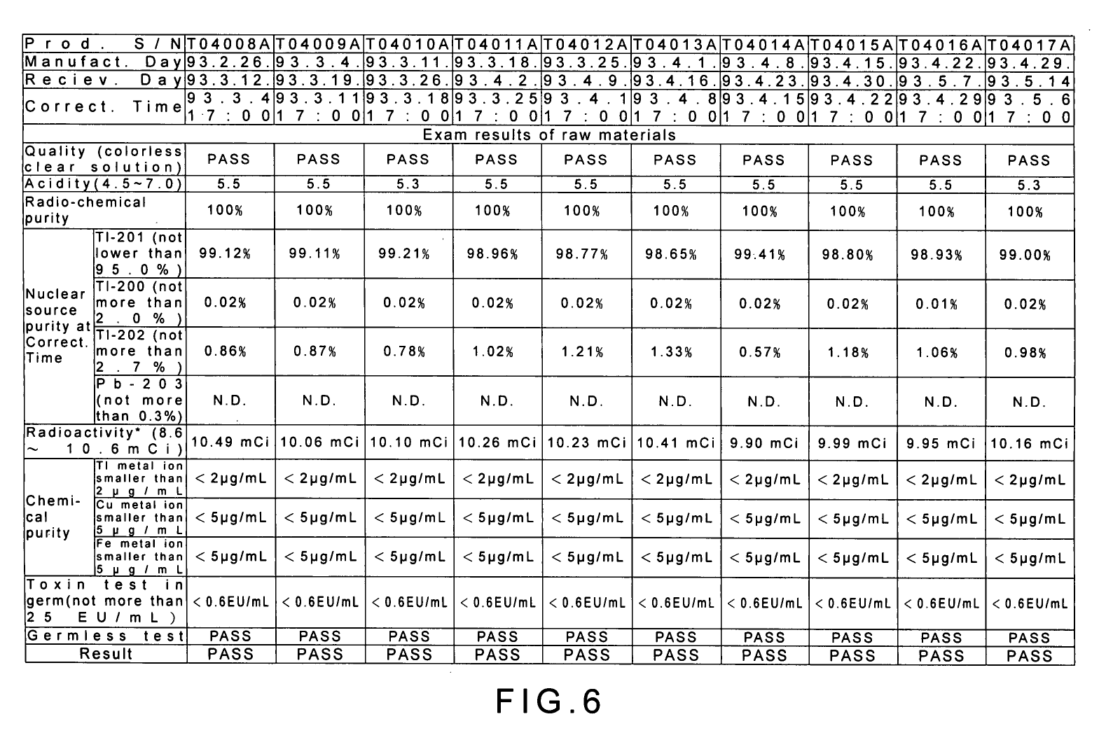

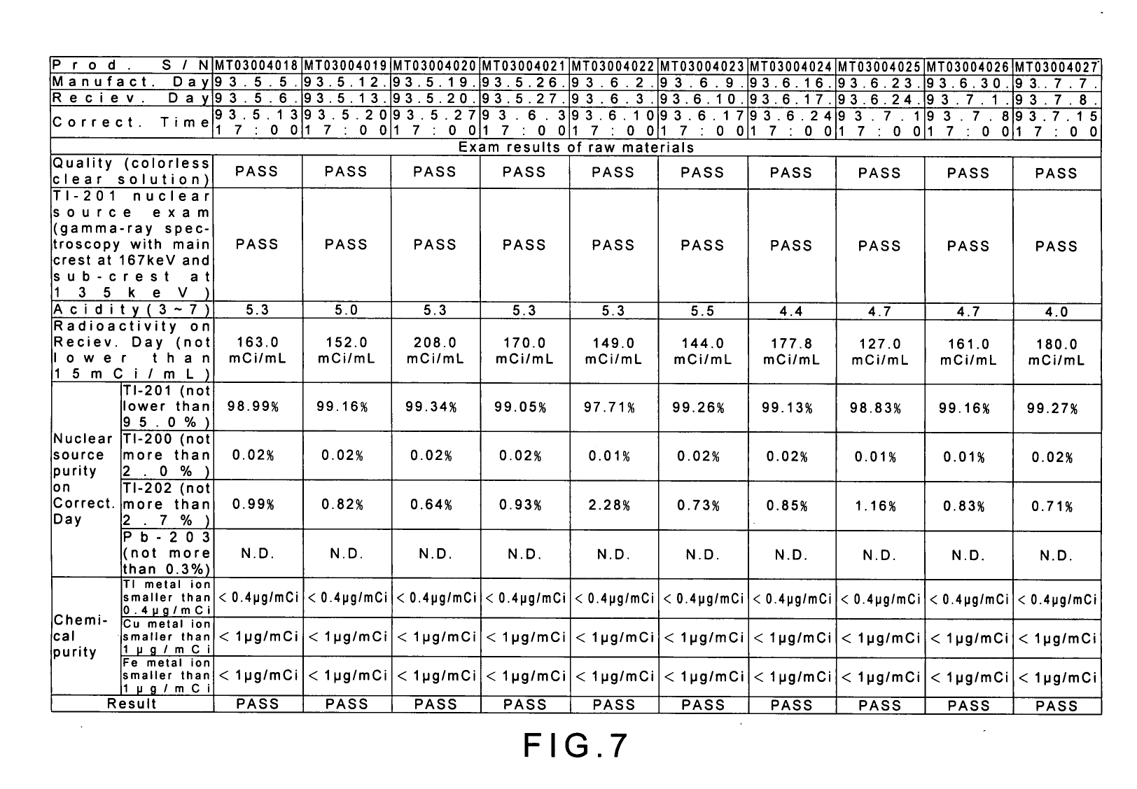

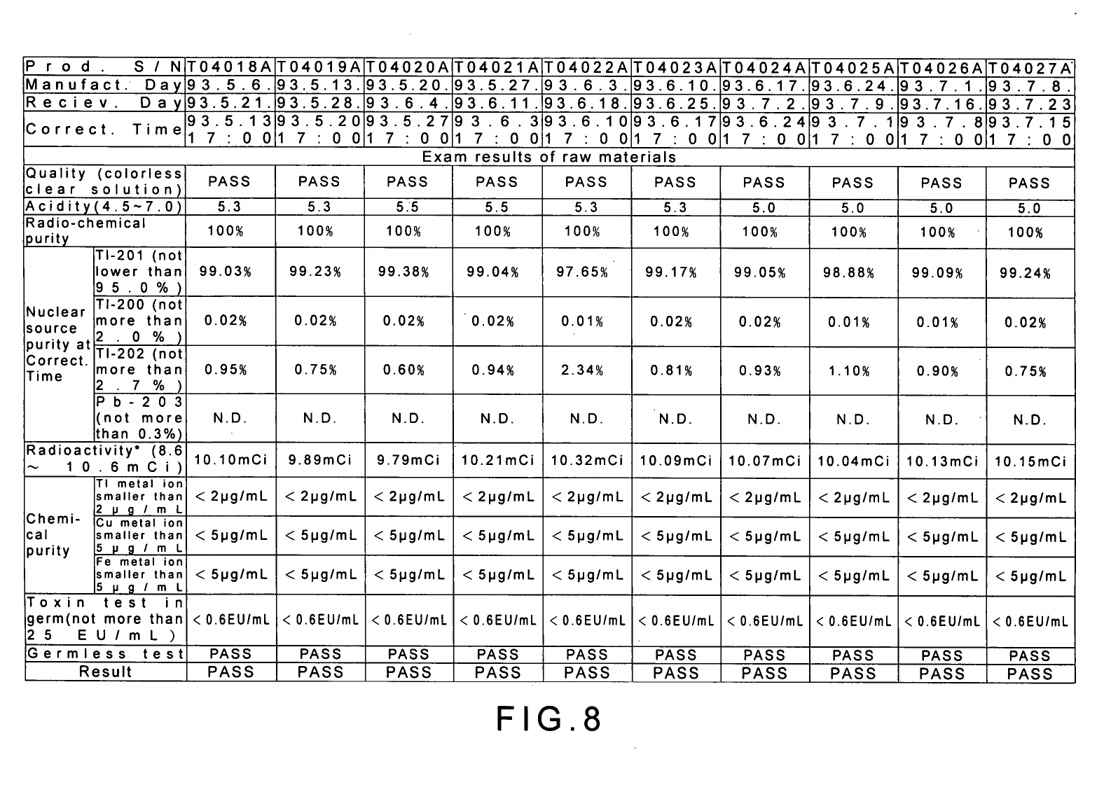

The raw materials recycled from the remnant of target electroplating solution or chemical solution and the injections made with the raw materials are examined and are all passed as shown in FIG. 5 to FIG. 8. To sum up, the present invention is a method for recycling TL-203 isotope in a remnant solution of TL-201 radioisotope, where a recycling rate over 98% is achieved and the chemical process flow is simple and convenient with high purity and high recycling rate through chemical precipitation and ion exchange. The present invention is used in an automatic or semi-automatic process, which improves the convenience and the repetition of the recycling and saves time and human resources.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method for recycling thallium(TL)-203 isotope in a remnant solution of TL-201 radioisotope comprising steps of:
(a) processing an ion exchange to a remnant electroplating solution of TL-203 target;
(b) washing said remnant electroplating solution with a sulphuric acid to obtain a first Tl-203 solution;
(c) adjusting pH (Potential of Hydrogen) value of said first Tl-203 solution with a NaOH solution to obtain a second Tl-203 solution having a pH value of 12;
(d) settling said second Tl-203 solution with a sulfide solution to obtain a solution having a precipitate of thallous sulfide;
(e) filtrating said solution having a precipitate of thallous sulfide with a filtrating tank to obtain said precipitate and a recycled solution; and
(f) rinsing said precipitate with a NaOH solution to obtain Tl-203 isotopes.

2. The method according to claim 1,
wherein said Tl-203 isotope is made into a solid thallous oxide.

3. The method according to claim 2,
wherein said solid thallous oxide is obtained by heating said Tl-203 isotope to 900° C.

4. The method according to claim 1,
wherein a target electroplating solution is obtained by adding said Tl-203 isotope.

5. The method according to claim 4,
wherein said target electroplating solution is obtained with a dissolvent of sulfuric acid.

6. The method according to claim 4,
wherein a method for obtaining said target electroplating solution comprises diluting and evaporating.

7. The method according to claim 1,
wherein a recycling rate of said Tl-203 isotope is over 98%

8. The method according to claim 1,
wherein said Tl-203 isotope is a raw material for an nucleo-medical injection of 201 thallous chloride (201TlCl).

9. The method according to claim 8,
wherein an irradiator to said injection is a cyclotron.

10. The method according to claim 1,
wherein said pH value after said adjusting pH value is a value between 12 and 13.5; and
wherein a recycling rate for said recycled solution is at least 97%.

11. The method according to claim 1,
wherein said recycled solution is recycled more than 20 times.

12. A method for recycling Tl-203 isotope in a remnant solution of Tl-201 radioisotope, comprising steps of:
(a) adjusting a pH value of a remnant chemical Tl-201 solution with a NaOH solution to obtain a Tl-201 solution having a pH value of 12;
(b) precipitating said Tl-201 solution having a pH value of 12 with a sulfide solution to obtain a solution having a precipitate of thallous sulfide;
(c) filtrating said solution having a precipitate of thallous sulfide with a filtrating tank to obtain said precipitate and a recycled solution; and
(d) rinsing said precipitate with a NaOH solution to obtain Tl-203 isotopes.

13. The method according to claim 12,
wherein said Tl-203 isotope is made into a solid thallous oxide.

14. The method according to claim 13,
wherein said solid thallous oxide is obtained by heating said Tl-203 isotope to 900° C.

15. The method according to claim 12,
wherein a target electroplating solution is obtained by adding said Tl-203 isotope.

16. The method according to claim 15,
wherein said target electroplating solution is obtained with a dissolvent of sulfuric acid.

17. The method according to claim 15
wherein a method for obtaining said target electroplating solution comprises diluting and evaporating.

18. The method according to claim 12,
wherein a recycling rate of said Tl-203 isotope is over 98%

19. The method according to claim 12,
wherein said Tl-203 isotope is a raw material for a nucleo-medical injection of 201 TlCl.

20. The method according to claim 19,
wherein an irradiator to said injection is a cyclotron.

21. The method according to claim 12,
wherein said pH value after said adjusting pH value is a value between 12 and 13.5; and
wherein a recycling rate for said recycled solution is at least 97%.

22. The method according to claim 12,
wherein said recycled solution is recycled more than 20 times.
